(19) United States
(12) Patent Application Publication
(10) Pub. No.: US 2016/0098094 A1
(43) Pub. Date: Apr. 7, 2016

(54) USER INTERFACE ENABLED BY 3D REVERSALS

(71) Applicant: Geegui Corporation, Helsinki (FI)

(72) Inventor: Sami Minkkinen, Helsinki (FI)

(21) Appl. No.: 14/873,230

(22) Filed: Oct. 2, 2015

Related U.S. Application Data
(60) Provisional application No. 62/058,695, filed on Oct. 2, 2014.

(51) Int. Cl. G06F 3/01

(52) U.S. Cl. CPC G06F 3/017

(57) ABSTRACT

A method and system are provided where a user can imitate a tap gesture with a fingertip in space without a physical surface to tap on and, if the trajectory of the fingertip is tracked in the course of movement, the tap gesture is performed by a 3D reversal. In a 3D reversal, the trajectory becomes substantially reversed.

### BACKGROUND OF INVENTION

Three-dimensional (3D) user interfaces have great potential to take human-computer interaction to the next level, especially in applications that are used to work with natively 3D content. If something is designed for the real, three-dimensional world by a computer, the content is commonly 3D. 3D content is also very common in virtual worlds, such as movies and games. Despite decades of research and development, no efficient and intuitive 3D user interface exists for such applications.

An intuitive user interface should allow the user to predict how it is used based on its appearance, wherein the prediction depends strongly on the past experiences of the user. For example, a phone keypad on a touch-screen is a very intuitive user interface because virtually all users can predict how it is used, that is, by tapping touch-screen keys. In other words, if a phone keypad is visualized for users, they commonly predict that the intended number is selected by tapping the right keys because that is the way keys have been used since the advent of push-button telephones, typewriters, and keyboards.

### SUMMARY OF THE INVENTION

In accordance with an example of the invention, the user can imitate a tap gesture with a fingertip in space without a physical surface to tap on and, if the trajectory of the fingertip is tracked in the course of movement, the tap gesture is performed by a 3D reversal. In a 3D reversal, the trajectory becomes substantially reversed. As disclosed in U.S. patent application Ser. No. 13/832,106, a 3D reversal can be recognized as soon as it is performed. Therefore, tapping in space can be recognized in accordance with an example of the invention, providing an intuitive and efficient way for selections in 3D user interfaces. For example, if a virtual phone keypad is visualized in a 3D user interface (for example, with a head-mounted display), the most intuitive way to dial number is by tapping the virtual phone keypad with a fingertip. Such dialing is possible in accordance with an example of the invention. Furthermore, such dialing is possible even if the user perceives the 3D location of the virtual phone keypad incorrectly and taps in front of the keypad. In such a case, a key can be determined by the direction of a 3D reversal; by finding the key towards which the 3D reversal is performed.

A virtual surface may have any kind of graphical element (keys, commands, menu items, buttons, two-dimensional objects, windows, etc.) and all of them can be selected by tapping in space in accordance with an embodiment. Furthermore, if the element is too small to be selected efficiently with a fingertip, the user can penetrate the virtual surface with the fingertip in order to zoom in for more accurate selection.

In addition to recognizing tapping in space near a virtual surface, 3D reversals can also be utilized for other selections in accordance with an embodiment. For example, the user can select an object (virtual or real) with a 3D reversal of a fingertip even if the object is beyond arm's reach. In order to guide the user to perform the correct selection, a teleselection line can be visualized in the direction of movement of the fingertip.

Furthermore, in accordance with an embodiment, the user can move a virtual object in a virtual environment with 3D reversals of a fingertip. This is intuitive because 3D reversals are also commonly used to move real objects. Unlike with real objects, virtual objects can also be moved from a distance with a teleselection line in accordance with an embodiment.

In accordance with an embodiment, the user can form a hand posture with a hand and subsequently indicate the correctly formed hand posture with a 3D reversal of the hand. This way unwanted hand postures that are performed accidentally can be eliminated. In addition, the user can perform the 3D reversal towards an object (virtual or real), meaning that the hand posture is directed at the object. For example, in augmented reality, the user can walk out of a restaurant after a meal and perform a thumb-up or a thumb-down hand posture towards the restaurant depending on whether the user liked the meal or not.

In addition, 3D reversals enable trajectorial gestures to be separated from the other freehand movements in accordance with an embodiment. The user can perform a trajectorial gesture with accurate beginning and ending points in space in any direction.

Also, in accordance with an embodiment, 3D reversals enable the design of hand gestures such as manipulative gestures or navigational gestures that can be determined as separate from other freehand movement. Navigational gestures enable the user to concurrently translate the point of view in 3D, rotate the point of view around a point of interest about three perpendicular axes, and change the angle of view. Manipulative gestures enable the user to concurrently scale and manipulate a virtual object with six degrees of freedom (3D translation and rotation about three perpendicular axes).

As disclosed herein, 3D reversals enable an efficient and intuitive user interface.

### BRIEF DESCRIPTION OF THE DRAWINGS

FIG. 1 illustrates a virtual phone keypad on a virtual surface in a 3D user interface and a tap gesture in space in accordance with an embodiment.

FIG. 2 illustrates how a graphical element can be determined as selected in accordance with an embodiment if the user performs a tap gesture in front of a virtual surface.

FIG. 3 illustrates a zooming mode in accordance with an embodiment.

FIG. 4A and FIG. 4B illustrate how a virtual object can be selected from a distance with a teleselection line in accordance with an embodiment.

FIG. 5 illustrates moving a virtual object with two 3D reversals in accordance with an embodiment.

FIG. 6 illustrates moving a virtual object from a distance with a teleselection line in accordance with an embodiment.

FIG. 7 illustrates how the user can approve a restaurant in augmented reality in accordance with an embodiment.

FIG. 8 illustrates how a virtual object can be entered with a trajectorial gesture in accordance with an embodiment.

FIG. 9A and FIG. 9B illustrate a navigational gesture in accordance with an embodiment.

FIG. 10 illustrates the orientation of a hand and fingers relative to a virtual object at the beginning of a manipulation in a manipulative gesture in accordance with an embodiment.

FIG. 11A and FIG. 11B illustrate the usage of a head-mounted display and a smart watch in accordance with an embodiment.

### DETAILED DESCRIPTION OF EXEMPLARY EMBODIMENTS

In accordance with an example of the invention, the user can imitate a tap gesture with a fingertip in space without a physical surface to tap on and, if the trajectory of the fingertip is tracked in the course of movement, the tap gesture is performed by a 3D reversal. In a 3D reversal, the trajectory becomes substantially reversed. As disclosed in U.S. patent application Ser. No. 13/832,106, which is incorporated by reference in its entirety herein, a 3D reversal can be recognized as soon as it is performed. Therefore, tapping in space can be recognized in accordance with an example of the invention, providing an intuitive and efficient way for selections in 3D user interfaces.

In some embodiments, a method is provided for constructing tracking data of body parts of a user (arms, hands, and fingers, for example). A computing device performing the method can have adequate light sources and detectors, or other means for detecting, embedded and/or in communication via a communication link. For the purpose of constructing tracking data, body parts can be observed from a plurality of points and tracked by means of triangulation, for example. In addition, body parts can be illuminated with infrared light and tracked using projections of the body parts at observation points. Also, body parts can be illuminated with a known structured infrared light (or other light) and tracked using observed deformations of the structured light on the body parts. When infrared light is used for illumination, it is preferable to use those wavelengths at which the blackbody spectrum of the sun is greatly absorbed by the atmosphere in accordance with the embodiment. Furthermore, markers can be attached to body parts and the method can construct tracking data by using sensed location (and possibly orientation) of the markers. In addition, information from 3D accelerometers and/or gyroscopes attached to body parts, as well as information from radiometric triangulation, can be used for constructing tracking data. Possibly information from EMG muscle sensors can be used for constructing tracking data. It is possible to track body parts by several means simultaneously and use sensor fusion for a more accurate result. Tracking data can be enhanced and/or interpreted with a model of the human anatomy.

As an alternative to constructing tracking data, a computing device can receive tracking data via a communication link. Or, a computing device can receive a part of tracking data.

In some embodiments, a method is provided for generating position information of a user's body part. The method includes sampling the position of the body part based on tracking data. A body part is represented by a tracked body part in the tracked data. A tracked body part can be used for sampling the position of the body part. The position of a tracked body part can be determined based on a tracked point. A tracked point can be set to be on the tracked body part or in the tracked body part, or it can substantially move along with the tracked body part.

In embodiments in which a computing device is attached to a body part, a method can be provided for generating position information of the body part based on the position of the computing device.

In some embodiments, a method is provided for receiving position information of a user's body part via a communication link.

In some embodiments, a method is provided for notifying listeners of positional changes of a body part of a user. The method can include acquiring position information of the body part. The position information acquired can result from methods for generating or receiving it. Such methods are exemplified just above. The method for notifying listeners can include receiving a registration from a listener declaring to receive position events. The position events notify the listener of positional changes. The method can further include detecting a positional change based on the position information and, upon detecting the positional change, generating a position event for notifying the registered listeners. The position event can comprise the position of the body part after the positional change.

In accordance with an embodiment, a position of a body part of a user can be determined relative to different frames of reference. For example, the earth, a vehicle, a computing device, the user, and a body part of the user can be a frame of reference. Also positional changes can be determined relative to different frames of reference.

In accordance with an embodiment, a method is provided for generating reversal events. The method can include creating a sampled trajectory. The method can further include registering to receive position events, the position events notifying of positional changes of a body part of a user, receiving a position event, the position event comprising a position of the body part, and, in response to receiving the position event, updating the sampled trajectory with the position. The method can further include performing reversal recognition on the updated sampled trajectory to identify a reversal, and, upon identifying the reversal, generating a reversal event. The method can further include receiving a registration from a listener, wherein the listener declares to receive reversal events and, upon generating the reversal event, notifying registered listeners by the reversal event.

A sampled trajectory can comprise sampled positions of a body part of a user, or sampled points, in a chronologically ordered list. A list item comprising a sampled position can comprise other related information, such as the time stamp of sampling. A sampled trajectory can be seen as a digital representation of the trajectory of the body part. In some embodiments, a method includes providing a visualization of a sampled trajectory for presentation via a user interface, enabling the user to see the sampled trajectory. In such a visualization, successive sampled positions can be connected with straight line segments, for example.

In the method for generating reversal events, performing reversal recognition can include calculating a rate of reversing at sampled positions in the sampled trajectory and identifying the reversal when the rate of reversing is above a minimum rate at one or more subsequent sampled positions. In the method, performing reversal recognition can further include determining the maximum rate of reversing among the one or more sampled positions and determining a sampled position, of the one or more sampled positions, having the maximum rate of reversing as a tip point of the reversal. A rate of reversing can be quantified at a sampled point as one (1) minus a ratio calculated by dividing the sum of pairwise distances of point pairs by the maximum. A pairwise distance means the distance between the two points in a pair. The maximum can be determined under the same constructing scheme for constructing point pairs by calculating the sum of pairwise distances at a point on a line because the line is as far as possible being a reversal at the point. On the other hand, the sum of pairwise distances is zero at the tip point of a perfect reversal because point pairs are at the same locations. If the rate of reversing is above a minimum rate, the rate of reversing at the sampled point can be determined to be substantial. The minimum rate can be 0.1, 0.2, 0.3, 0.4, 0.5, 0.6, 0.7, 0.8, or 0.9, for example. The minimum rate can also be set by the user or it can learned from usage data.

Additionally, performing reversal recognition can include determining a correlation between two paths of the object from a sampled trajectory, or updated sampled trajectory, wherein when the position of two paths of the object from the sampled trajectory meet a predetermined correlation index and the two paths have opposite trajectories, a reversal is recognized. A portion of a sampled trajectory can be considered a path. For example, a sampled trajectory of a user moving their finger in a clicking motion of a mouse can be separated into two paths, a first path which tracks the finger in the downward clicking motion and a second path which tracks the finger's motion back to a starting position. The two paths in such an example can be analyzed to determine that there is a correlation between the position of the paths, e.g. analyzing only the position data of the paths and how closely the position data from the two paths overlaps in space. If the analysis determines that the position data of the two paths sufficiently overlaps in space, e.g. by using a correlation index, and the direction or trajectory of the two paths is opposite, then it can be determined that a reversal has taken place. The correlation index can be used since in a three dimensional environment, it is unlikely that the position data for two paths would be identical, however, if there is sufficient correlation between the two paths this can be sufficient for determining that a reversal has taken place.

In accordance with an embodiment, different means can be used for displaying a user interface for the user. For example, head-mounted displays can be used. Emerging technologies able to generate light fields, such as microlens arrays and wave guide reflector arrays, are about to provide lightweight head-mounted displays and enabling 3D visualization of user interface. In optical see-through devices, or in augmented reality devices, the user is able to see body parts and a visualization of a sampled trajectory, for example, at the same time.

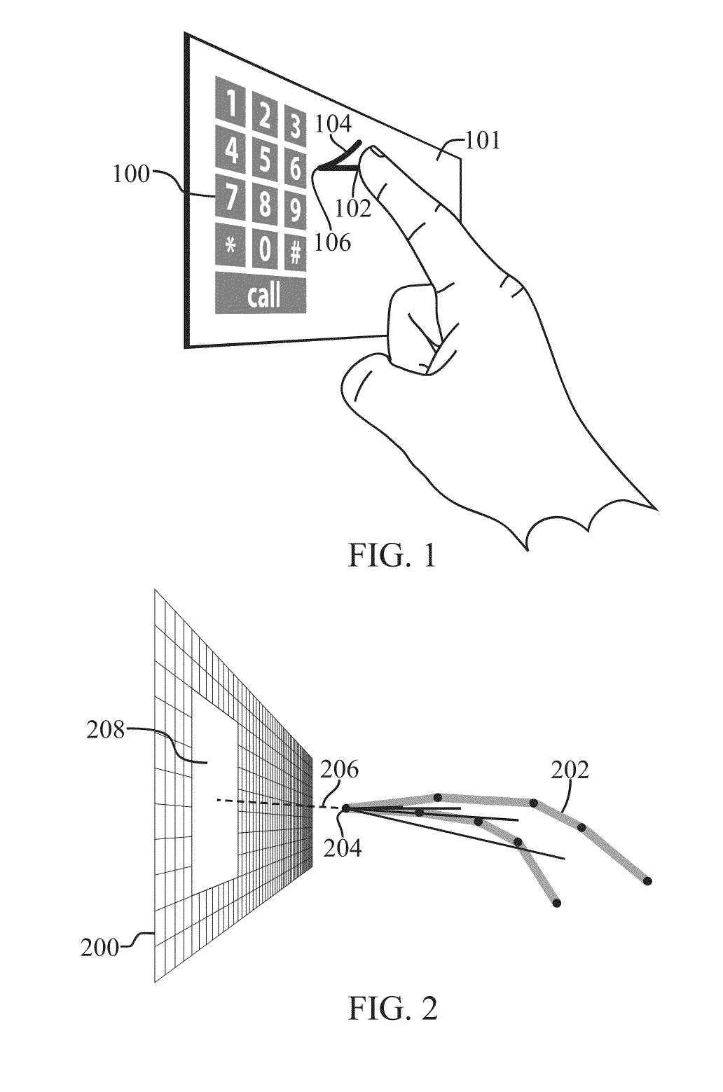

FIG. 1 illustrates a virtual phone keypad 100 on a virtual surface 101 in a 3D user interface and a tap gesture in space in accordance with an embodiment. The 3D user interface, along with the virtual phone keypad 100, can be visualized with a head-mounted display, for example. The most intuitive way to dial a number is by tapping the virtual phone keypad 100 with a fingertip 102. Such dialing is possible in accordance with the embodiment. Furthermore, such dialing is possible even if the user perceives the 3D location of the virtual phone keypad 100 incorrectly and taps in front of the keypad, as is the case in FIG. 1. The sampled trajectory 104 of the fingertip 102 contains a 3D reversal with the tip point 106 as illustrated and the sampled trajectory 104 does not penetrate the virtual surface 101.

3D reversals can have particularly good properties for recognizing tap gestures in space in accordance with an embodiment. For example, it is possible to recognize the direction of a 3D reversal, in addition to the tip point of the 3D reversal. The tip point can be characterized as the likely point where reversing has begun. Commonly the movement direction has the largest change at the tip point. When tapping a physical surface, the tip points of 3D reversals are in alignment with the physical surface (in other words, the movement direction of a fingertip is reversed on the physical surface) and reversals are towards the physical surface. On the other hand, when tapping a virtual surface in space, the tip points of 3D reversals may not be in alignment with the virtual surface, as the user may perceive depth inaccurately. In accordance with an embodiment, it is not devastating if the user performs a tap gesture in front of a virtual surface because a graphical element (a key, a command, a menu item, a button, a two-dimensional object, a window, etc.) on the virtual surface can be determined by the direction of a 3D reversal, by finding the graphical element towards which the 3D reversal points, as illustrated in FIG. 2. This is intuitive for the user as 3D reversals are towards graphical elements when selected by tapping a physical surface (such as a touch-screen). Recognizing the direction of a 3D reversal is not known in prior art and it is exemplified along with illustrations in with FIG. 2.

FIG. 2 illustrates how a graphical element can be determined as selected in accordance with an embodiment if the user performs a tap gesture in front of a virtual surface 200. The embodiment relates to a selection operation. A sampled trajectory is constructed while the tap gesture is performed. An interpolation path 202 (illustrated with gray) is constructed by connecting successive sampled positions in the sampled trajectory (illustrated with black dots) with straight line segments. As can be seen by the interpolation path 202, the sampled trajectory contains a 3D reversal (which can be recognized as described above) with the tip point 204 as illustrated. The 3D reversal is directed towards the virtual surface 200. The direction of the 3D reversal can be recognized, for example, by using the point pairs interpolated along the interpolation path 202. As described in more detail in U.S. patent application Ser. No. 13/832,106, the two points in a point pair are equally far from, but in opposite directions to, the tip point 204 along the interpolation path 202. The direction of the tip point 204 relative to these equally far points can be estimated by constructing two vectors from the two points in a point pair to the tip point 204 first and then taking the mean of these two vectors. Mean vectors are illustrated with black solid line segments for four point pairs in FIG. 2 (one end of which are at the tip point 204). The further away along the interpolation path 202 two points in a point pair are (that is, the longer the black solid line segment in FIG. 2 is), the more irrelevant the direction of the mean vector is to the direction of the 3D reversal. In other words, the trajectory close to the tip point 204 is more meaningful for the direction of the 3D reversal. This can be taken into account in recognizing the direction of the 3D reversal by calculating the weighted sum of unit vectors of the mean vectors, wherein unit vectors corresponding to point pairs that are closer to the tip point 204 receive a larger weighting. The black dashed line 206 represents the direction of the 3D reversal when the direction is recognized using such a weighted sum. After the direction of the 3D reversal is known, it is the matter of finding an intersecting graphical element on the virtual surface 200 for that direction. In FIG. 2, an intersecting graphical element 208 is found and it can be determined as selected.

A physical surface is good in that it provides tactile feedback when tapped but a body part can't penetrate it. However, a virtual surface, having a plurality of graphical elements (keys, commands, menu items, buttons, two-dimensional objects, windows, etc.), can be penetrated by a body part and the penetration can be utilized in different ways in accordance with an embodiment.

For example, the penetration can be utilized in such a way that in order to select a graphical element on the virtual surface, the user can penetrate the graphical element first and then perform a tap gesture, or a 3D reversal. Therefore, in accordance with an embodiment, the user can perform a tap gesture, or a 3D reversal, before (see the description above along with FIG. 2) or after in order to select a graphical element on a virtual surface. This is important for usability as the virtual surface is, by definition, dimensionless if it is penetrated perpendicularly. Depending on the graphical element, determining it as selected can cause different instructions to be executed in the user interface, such as executing the selected command, opening the selected menu, adding the selected character, and so on.

In addition, the penetration can be utilized in such a way that a zooming mode for more accurate selections can be initiated after penetration in accordance with an embodiment. For example, the virtual surface, or graphical elements on the virtual surface, can be zoomed in or out at a zooming point as a function of a distance between the virtual surface and the body part. In addition, parallel movement of the body part with the virtual surface can be used to move the zooming point wherein the rate of movement can be determined as a function of the distance (between the virtual surface and the body part. A convenient zooming mode can be implemented if, with increasing distance, the virtual surface is zoomed in and the rate of movement (of the zooming point) decreases. The zooming point can be initiated to the point of penetration. Also within such a zooming mode the user can make a selection with a 3D reversal in accordance with an embodiment. Again, the direction of the 3D reversal is a particularly good property because the direction can be used to identify only those 3D reversals as selective tap gestures that are substantially directed away from the virtual surface (the direction is away as the virtual surface has already been penetrated). In other words, the user can make 3D reversals parallel with or towards the virtual surface in relocating the zooming point and in zooming out in order to make the correct selective tap gesture with ease. For example, and more specifically, the user can zoom out by decreasing the distance after increasing the distance if the user does not make a selective tap gesture, or a 3D reversal substantially directed away from the virtual surface, in between. In addition, the user can cancel the entire selection process by moving the body part back to the side it penetrated from without making a selective tap gesture in between.

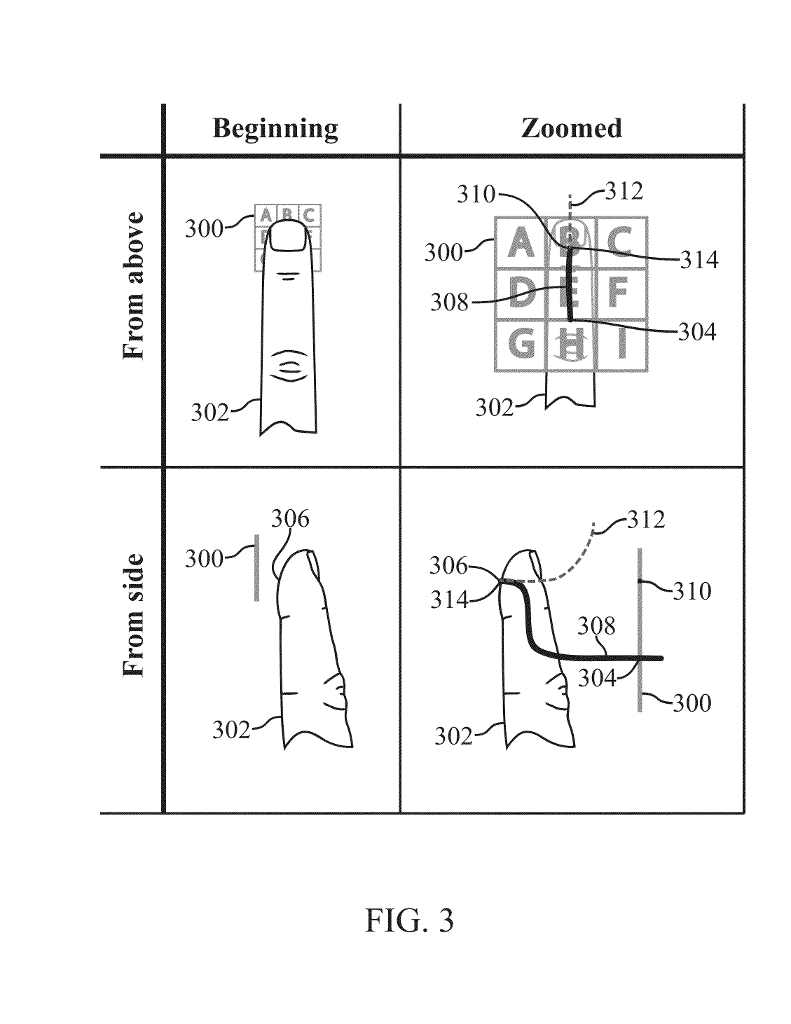

FIG. 3 illustrates a zooming mode in accordance with an embodiment. The embodiment relates to a selection operation. FIG. 3 has four cells in order to illustrate two situations from two different angles, from above and from the side. In the beginning (the left column), a virtual surface 300 is under a finger 302. The virtual surface 300 has nine rectangular graphical elements, each of which is too small, relative to the finger 302, to be selected effectively. In accordance with an embodiment, the user can penetrate the virtual surface 300 in order to zoom in for more accurate selection, as illustrated in the right column. More specifically, the virtual surface 300 is penetrated at the point 304 of penetration by the fingertip 306, as illustrated with the sampled trajectory 308 of the fingertip 306. The fingertip 306 is a tracked point in the example. The zooming point is initiated to the point 304 of penetration. The sampled trajectory 308 shows that the user first zoomed in (as the distance between the virtual surface 300 and the fingertip 306 has increased) and then, at a convenient zooming level, the user relocated the zooming point into the borders of the intended graphical element (that is, the graphical element named “B”) with a movement parallel to the virtual surface 300. Finally, the movement is turned away from the virtual surface 300. In the situation illustrated in the right column, the zooming point is at location 310. A gray path 312 illustrates how the user could continue from the situation illustrated in the right column in order to select the “B” graphical element in the zooming mode. More specifically, the user could perform a 3D reversal that is substantially directed away from the virtual surface 300. Then, as illustrated, the tip point 314 of the 3D reversal would be within the “B” graphical element, specifying the “B” graphical element as the one to be selected. As illustrated in the top-right cell, the virtual surface 300 is zoomed in enough in order to facilitate selection.

Humans are capable of using a body part to tap on a small physical object quite quickly even if the object is almost at arm's length. Such tapping begins with a fast movement in approximately the right direction and ends with a considerably slower movement and fine adjustments in direction. Just before the object is hit, the direction is towards the object; otherwise the object is most likely missed (depending on the size). These findings can be used in accordance with an embodiment. For example, a teleselection line can be constructed, and visualized for the user, in the direction of movement. As soon as the teleselection line intersects the intended object (the intersected object can be highlighted), the user can perform a 3D reversal in order to select the object. The closer a body part is to the intended object, the more likely the teleselection line is towards the object, enabling small objects to be selected. However, it is sufficient to perform a short movement in approximately the right direction for large objects because it is easier intersect them with the teleselection line. The user can therefore make a selection without moving the body part all the way to the depth of the intended object, thereby reducing selection time significantly. Furthermore, the intended object may be beyond arm's reach, such as in the case of distant real objects in optical see-through devices or in augmented reality devices. A teleselection line and a 3D reversal can also be used for making selections in these cases. A teleselection line can also be used for selecting graphical elements on a virtual surface. It should be noted that the user can easily perform a 3D reversal for all directions of movement.

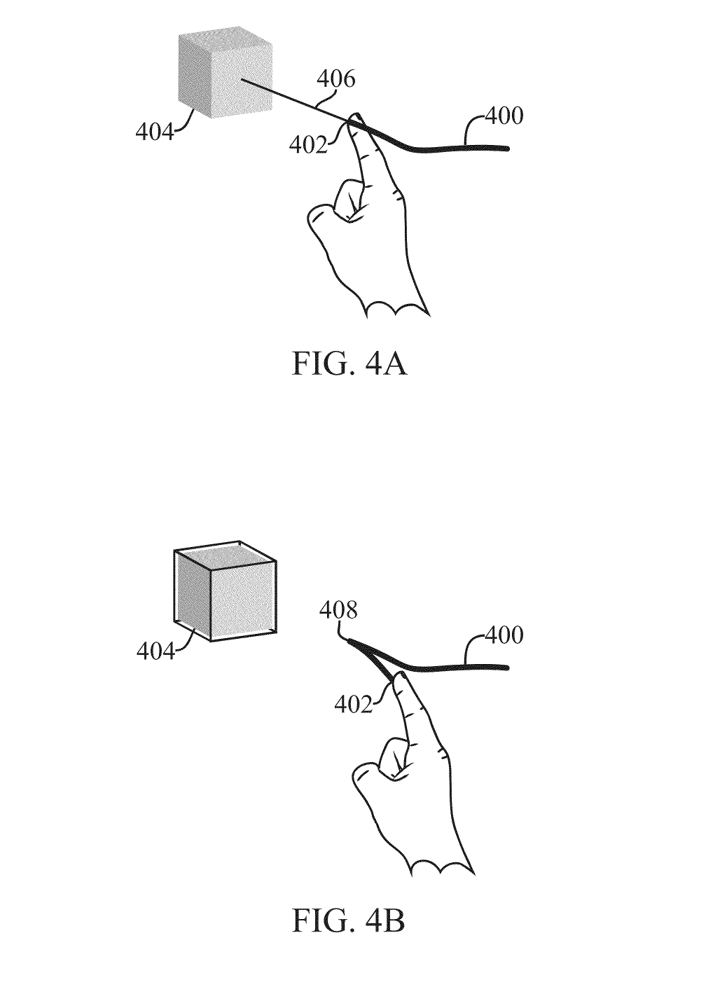

FIGS. 4A and 4B illustrate how a virtual object can be selected from a distance with a teleselection line in accordance with an embodiment. The embodiment relates to a selection operation. In the situation illustrated in FIG. 4A, the user has performed a sampled trajectory 400 with the fingertip 402 of an index finger towards a virtual object 404. The fingertip 402 is a tracked point in the example. A teleselection line 406 is visualized in the direction of movement, as illustrated in FIG. 4A. Because the teleselection line 406 intersects the virtual object 404, the user has performed a 3D reversal in order to select the virtual object 404, as illustrated in FIG. 4B. The virtual object 404 is visualized as selected with a frame around the virtual object 404. The sampled trajectory 400 in FIG. 4A is continued in FIG. 4B. It should be noted that the selection is performed from a distance. In other words, the tip point 408 of the 3D reversal is far from the virtual object 404.

If a virtual object is within arm's reach, it can be selected by performing a 3D reversal in such way that the tip point of the 3D reversal is inside the virtual object in accordance with an embodiment.

If the user wishes to select a plurality of virtual objects, whether they are beyond or within arm's reach, the user can indicate this with a predetermined orientation of the fingers and select the virtual objects individually in accordance with an embodiment. For example, the thumb and the index finger are not clenched, but the others are, in the predetermined orientation. Alternatively, the user can select a plurality of virtual objects from a distance with one 3D reversal. For example, the user can unclench all fingers in order to initiate a teleselection cylinder. The diameter of the teleselection cylinder can be set to the distance between the tips of the thumb and the little finger. The teleselection cylinder can be visualized for the user in the direction of movement of the hand and, as soon as the teleselection cylinder intersects the intended objects, the user can perform a 3D reversal with the hand in order to select the objects. The diameter of the teleselection cylinder can increase with the increasing distance from the point of view in order to take perspective into account. The user can set the reach of a teleselection cylinder, as well as the reach of a teleselection line, to certain limits in order to operate with objects within those limits.

In accordance with an embodiment, 3D reversals can be used intuitively to move virtual objects in virtual environments because 3D reversals are commonly used to move real objects. For example, when the trajectory of a hand is examined as it grabs a real object from a table and puts the object in a new location on the table, a 3D reversal is commonly performed in the both stages, while grabbing and while putting the object down (assuming that the object is not slid along the table). The same is true when someone reaches to a shelf to grab a real object and subsequently reaches to another shelf to put the object in a new location. However, grabbing is an inaccurate gesture for virtual object selections in virtual environments because it is done by a relatively large hand. Furthermore, it takes time to perform a grabbing gesture and the grabbing gesture itself might be difficult to recognize. Therefore, in accordance with an embodiment, a virtual object in a virtual environment can be moved with 3D reversals of an index finger (as it is natural and accurate to use the index finger to point; however, another body part can also be used). More specifically, the user can select the intended virtual object using a first 3D reversal and specify a new location for the object to be moved to using a second 3D reversal. If a real world analogue for such a move is imagined, it is as if the object sticks to the index finger when tapped with the index finger and unsticks in the following tapping, remaining at that location in space.

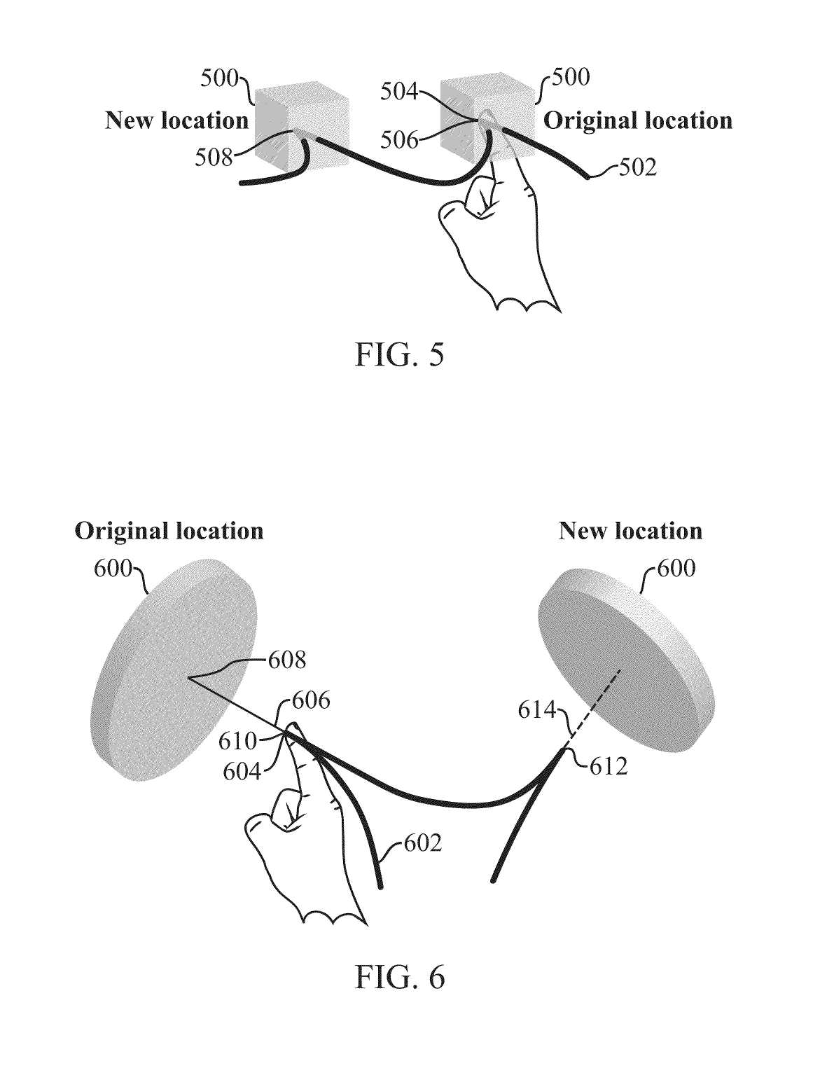

FIG. 5 illustrates moving a virtual object with two 3D reversals in accordance with an embodiment. The embodiment relates to a moving operation. The original location and the new location of a virtual object 500 are both illustrated in FIG. 5. The user has performed a sampled trajectory 502 with the fingertip 504 of an index finger. The fingertip 504 is a tracked point in the example. The virtual object 500 is selected for moving by performing a first 3D reversal in such a way that the tip point 506 of the first 3D reversal is inside the virtual object 500. The new location to which the virtual object 500 will be moved is specified with a second 3D reversal. The virtual object 500 can be moved in such a way that both tip points—the tip point 506 of the first 3D reversal and the tip point 508 of the second 3D reversal—become in the same locations relative to the virtual object 500. In other words, the user specifies a point in the virtual object 500 with the tip point 506 of the first 3D reversal first and then the user specifies where the point is moved to with the tip point 508 of the second 3D reversal.

Unlike with real objects, virtual objects can also be moved from a distance with a teleselection line in accordance with an embodiment. More specifically, as soon as the teleselection line intersects the intended object, the user can perform a first 3D reversal in order to select the object for moving and begin to move the object. When the first 3D reversal is performed, the position of the object relative to the tip point of the first 3D reversal can be recorded. This position can be kept constant in the course of movement, meaning that the object moves along with the body part (or along with a tracked point) a constant distance away in a constant direction. When the object is moved to the correct location, the user can perform a second 3D reversal in order to leave the object there. Alternatively, the distance between the body part and the object is kept constant in the course of movement but the object is in the direction of movement. This way it is easier to move the object from one direction to another, as illustrated in FIG. 6. Alternatively, the distance is changed to zero, or to another convenient value, right after the first 3D reversal in order to bring a distant object closer.

FIG. 6 illustrates moving a virtual object from a distance with a teleselection line in accordance with an embodiment. The embodiment relates to a moving operation. The original location and the new location of a virtual object 600 are both illustrated in FIG. 6. The user has performed a sampled trajectory 602 with the fingertip 604 of an index finger towards the virtual object 600. The fingertip 604 is a tracked point in the example. A teleselection line 606 is visualized in the direction of movement, as illustrated in the situation on the left. Because the teleselection line 606 intersects the virtual object 600, the user has performed a first 3D reversal in order to select the virtual object 600 for moving. Subsequently, the user has performed a second 3D reversal in order to specify the new location for the virtual object 600. To describe moving more specifically in terms of an algorithm, an intersection point 608 between the teleselection line 606 and the virtual object 600 can first be calculated and then the virtual object 600 can be rotated and translated (with help of another reference point within the virtual object 600) so that the intersection point 608 becomes the same location relative to both tip points, the tip point 610 of the first 3D reversal and the tip point 612 of the second 3D reversal, in the direction of the movement before the tip points. The dashed line 614 illustrates the direction of the movement before the tip point 612 of the second 3D reversal.

In accordance with an embodiment, copying can be accomplished in the form of a move with the exception that a copy of a virtual object remains in the original location. The user can use a different orientation of the hand and/or fingers in order to indicate whether the virtual object is to be copied or moved. In addition, the user can select a plurality of virtual objects first and then move or copy them.

In accordance with an embodiment, 3D reversals enable the user to perform hand postures efficiently and with ease. A hand posture is static in the sense that the hand and fingers are held in a certain orientation. Thumb-up and thumb-down are examples of hand postures. Hand postures have a great potential to provide richer interaction for user interfaces. However, recognizing them has been very problematic. More specifically, the user can accidentally perform unwanted hand postures while casually moving hands, or while forming the intended hand posture. The greater the number of hand postures that are utilized in a user interface, the bigger problem this becomes. In accordance with an embodiment, the user can form a hand posture with a hand and subsequently indicate the correctly formed hand posture with a 3D reversal of the hand. This means that the user can form the intended hand posture without erroneously performing other postures while doing so, enabling a large number of hand postures to be utilized. It is easy to perform a 3D reversal with the same hand with which a hand posture is formed. It is possible to associate different meanings if the same hand posture is performed with different hands. Furthermore, the user can give hand postures simultaneously, or in parallel, with two hands.

In accordance with an embodiment, the user can form a hand posture with a hand and subsequently indicate the correctly formed hand posture with a 3D reversal of the hand to certain directions. This is possible because the direction of the 3D reversal can be recognized. For example, the user may only be permitted to make an indication with a 3D reversal directed substantially away from the point of view of the user. Then, if the user wants to give many hand postures in succession, the user can move a hand back and forth somewhat radially and form the correct hand postures before the tip points of those 3D reversals which are directed away.

In accordance with an embodiment, the user can form a hand posture with a hand and subsequently indicate the correctly formed hand posture with a 3D reversal of the hand towards an object (virtual or real) or a graphical element. This means that the hand posture is directed at the object or at the graphical element, respectively. For example, the user can use a thumb-up posture to approve an object, a computer message, a picture, a post on social media, and so on by directing the 3D reversal accordingly. It should be noted that if the user wants to approve or disapprove the information on a graphical element (for example), the entire area of the graphical element can be used as the target towards which a 3D reversal of the hand (with the intended hand posture) is directed. Approving or disapproving is remarkably faster by such means than by tapping a small thumb-up or thumb-down icon near the graphical element.

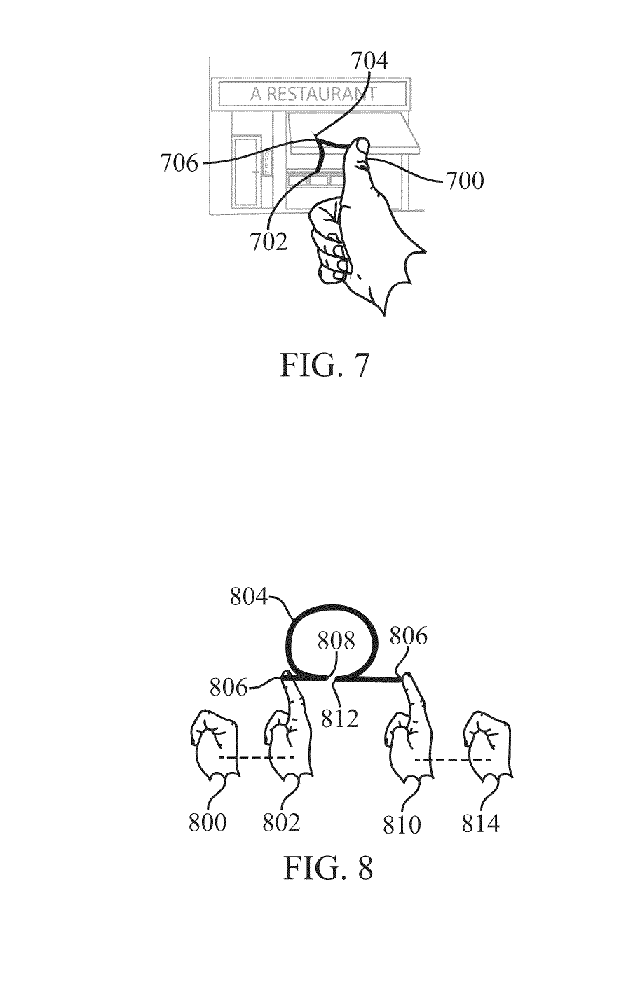

FIG. 7 illustrates how the user can approve a restaurant in augmented reality in accordance with an embodiment. The embodiment relates to a posture operation. The user has approved the restaurant (possibly after a meal) by performing a 3D reversal, with a thumb-up hand posture, towards the restaurant. In this example, the tip of a thumb 700 is used to perform a sampled trajectory 702 because a thumb is more accurate at pointing than a hand. Using a thumb in this way instead of a hand is possible because a hand posture is static, meaning that the thumb moves along with the hand. The tip of the thumb 700 is a tracked point in the example. A teleselection line 704, as illustrated in the figure in the direction of movement just before the tip point 706 of the 3D reversal, can be visualized for the user. The teleselection line 704 helps the thumb-up hand posture to be directed towards the right restaurant.

In accordance with an embodiment, hand postures may be recognized only after a 3D reversal is found because the user indicates the correctly formed hand posture with the 3D reversal of the hand. Furthermore, the orientation of the hand and fingers may need to be recognized only at the tip point of the 3D reversal. This remarkably decreases the computing burden in recognition, which is especially beneficial in mobile embodiments of the invention. Alternatively, if hand is recognized all the time, the list item comprising a sampled position can comprise the corresponding recognition result. When a tip point can be at sampled position, the list item of the tip point comprises the recognition result.

A subclass of gestures is based on the trajectories of a body part. This subclass of gestures is hereafter referred to as trajectorial gestures. In accordance with an embodiment, 3D reversals enable trajectorial gestures to be separated from the other freehand movements. To begin with, a specific orientation of body parts can be predetermined as a prerequisite for constructing a sampled trajectory. This specific orientation of body parts is hereafter referred to as an orientation prerequisite. From the user's point of view, an orientation prerequisite is performed first in order to perform a sampled trajectory. After an orientation prerequisite is recognized, the sampled trajectory is constructed by sampling a tracked point and a trajectorial gesture can be set to begin from the tip point of the subsequent 3D reversal. In addition, the trajectorial gesture can be set to end at the tip point of the preceding 3D reversal, after which the orientation prerequisite is no longer recognized. In this way, the user can perform a trajectorial gesture with accurate beginning and ending points in space in any direction, including 3D reversals in between. In accordance with an embodiment, trajectorial gestures can be used to enter commands, command parameters, text, objects, Bézier curves, curves, lines, etc. In addition, a single trajectorial gesture can be used for scope selection and command selection where a 3D reversal separates the two selections.

FIG. 8 illustrates how a virtual object can be entered with a trajectorial gesture in accordance with an embodiment. The embodiment relates to a trajectorial gesture operation. A user's hand is illustrated in four different situations. In the first illustrated situation 800 all of the fingers of the hand are clenched. In the second illustrated situation 802 the index finger is not clenched but the others are. In this example, this orientation of the fingers is an orientation prerequisite and the user performs a sampled trajectory 804 with the fingertip 806 of the index finger. The fingertip 806 is a tracked point in the example. Because the orientation prerequisite can be recognized in the second illustrated situation 802, construction of a sampled trajectory begins. After fulfilling the orientation prerequisite (in situation 802), the user performs the subsequent 3D reversal. This means that the trajectorial gesture begins from the tip point 808 of the subsequent 3D reversal. The orientation prerequisite is last recognized in situation 810, whereupon the sampled trajectory is no longer constructed. This means that the trajectorial gesture ends at the tip point 812 of the preceding 3D reversal. In the last illustrated situation 814 all of the fingers of the hand are clenched again. The two dashed lines illustrate the hand movement when the orientation of the fingers changes. The trajectorial gesture is almost a full circle, which could be used to enter a virtual sphere (for example) in a 3D user interface.

Unlike a hand posture, a hand gesture is dynamic in the sense that the orientation of the hand and the fingers are modified within the hand gesture. Perhaps the most difficult problem in recognizing hand gestures is to separate hand gestures or, in other words, to determine the beginning and the end of hand gestures. The following is a description of hand gestures for view navigation and virtual object manipulation tasks in 3D user interface in accordance with an embodiment. Both tasks are important tasks in user interfaces and separating these hand gestures is not a problem because of the way 3D reversals are used.

Because the orientation of the hand and the fingers is modified within a hand gesture, movement trajectories of all reference points within the palm and the fingers may contain unintentional 3D reversals. However, in accordance with an embodiment, a central point in the wrist joint is fairly free of unintentional 3D reversals. In addition, unintentional 3D reversals, if there are any, can be eliminated by various means. One way is to require that the user performs a 3D reversal in a predetermined direction. For example, it can be required that a 3D reversal with a central point in the wrist joint is performed substantially parallel with the forearm and towards the hand (or away the elbow), which is hereafter referred to as a forearm-parallel requirement. The forearm-parallel requirement could be used for navigational gestures and manipulative gestures, for example.

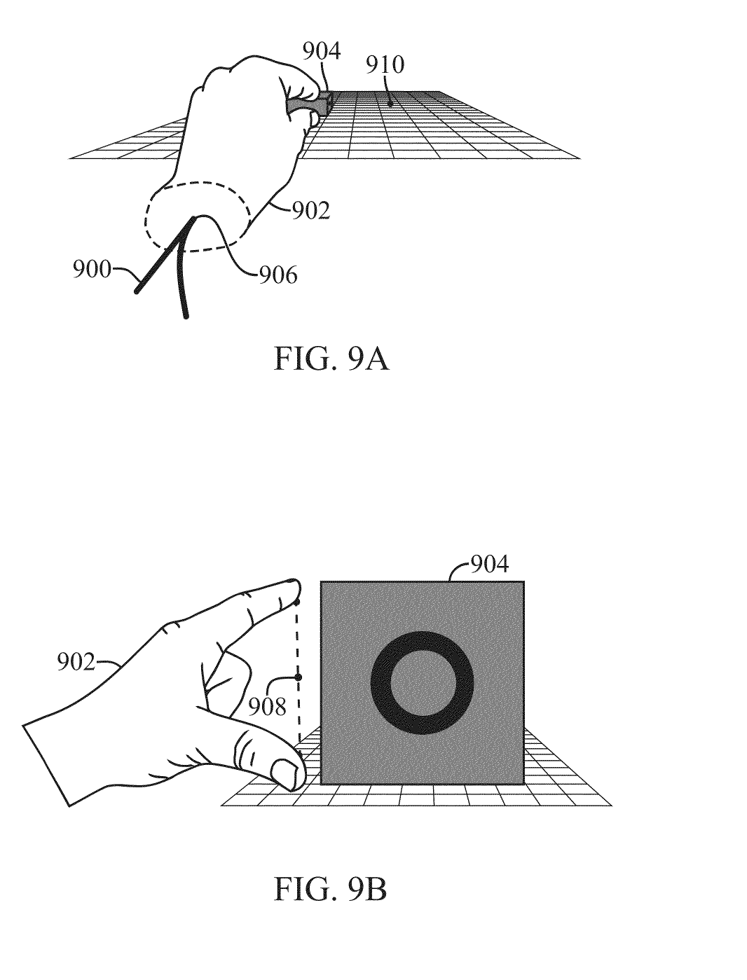

A virtual environment can be displayed for the user on a display means, for example on a head-mounted display. The user sees the virtual environment from a point of view with an angle of view. The point of view is directional in the sense that at each point in the virtual environment, the view can be seen in different directions. The angle of view relates to zooming. More specifically, if the angle of view is decreased, a smaller field of view is covered but, when the smaller field of view is expanded on a display means, the user perceives it as zooming in. In accordance with an embodiment, the user can navigate the view extensively using a navigational gesture. More specifically, the user can concurrently translate the point of view in 3D, rotate the point of view around a point of interest about three perpendicular axes, and change the angle of view. Such a navigational gesture is illustrated in FIGS. 9A and 9B.

FIGS. 9A and 9B illustrate a navigational gesture in accordance with an embodiment. The embodiment relates to a navigational operation. In FIG. 9A, a sampled trajectory 900 of a central point in the wrist joint of a hand 902 is illustrated. The central point is a tracked point in the example. The view of a virtual environment in FIG. 9A contains a distant virtual object 904. In order to see the virtual object 904 properly, the user can navigate the view with the navigational gesture as follows. Firstly, the user performs a first 3D reversal fulfilling the forearm-parallel requirement, as illustrated with the sampled trajectory 900 of the central point. After the first 3D reversal is recognized, the tips of the index finger and the thumb of the hand 902 are recognized at the tip point 906 of the first 3D reversal. This means that the user can specify two points in the virtual environment with the two fingertips by performing the first 3D reversal, which also initiates a view navigation. Before the view navigation ends, the point of view and the angle of the view are changed in such a way that the user perceives it as if the two points in the virtual environment are attached to the two fingertips. This means, for example, that the angle of view is decreased, or the virtual environment is zoomed in when the distance between the two fingertips is increased (as illustrated in FIG. 9B for increased distance). In addition, the point of view is rotated and/or translated if the location or rotation of the two fingertips changes, enabling the user to see a point of interest 908 (which can be set in between the two points) from different angles and distances. Rotation about the axis going through the two points can be determined with the direction of a third point within the hand 902 (for example). In FIG. 9B, the point of view is changed to such a location and direction that the user can see through the hole penetrating the virtual object 904. The point of view in FIG. 9B could be about location 910 in FIG. 9A. The user can end the view navigation by performing a second 3D reversal fulfilling the forearm-parallel requirement (not illustrated in FIGS. 9A and 9B). When the view navigation is ended, the point of view and the angle of view are reset to their settings at the time of the tip point of the second 3D reversal.

A real object can be manipulated with six degrees of freedom when grabbed with a hand, meaning that the real object can be translated in three dimensions and rotated about three perpendicular axes. Such manipulation is naturally limited by the human anatomy but within these limits, the six degrees of freedom are achieved. In addition, different tactics can be used to overcome the limits, including putting the object on a table between successive rotations in order to rotate the object more (a similar tactic is used when a screw cap is opened).

A virtual object can be concurrently scaled and manipulated with six degrees of freedom with a manipulative gesture in accordance with an embodiment. The manipulative gesture is intuitive because the user can move virtual objects with 3D reversals (3D reversals are also commonly used to move real objects—see the more detailed description above), which also provides, at the same time, a way to separate the manipulative gesture from other freehand movement. In addition, translating and rotating a virtual object has an analogue in real object manipulation. The manipulative gesture is limited by the human anatomy as for the manipulation of real objects but the limits can be overcome intuitively with 3D reversals.

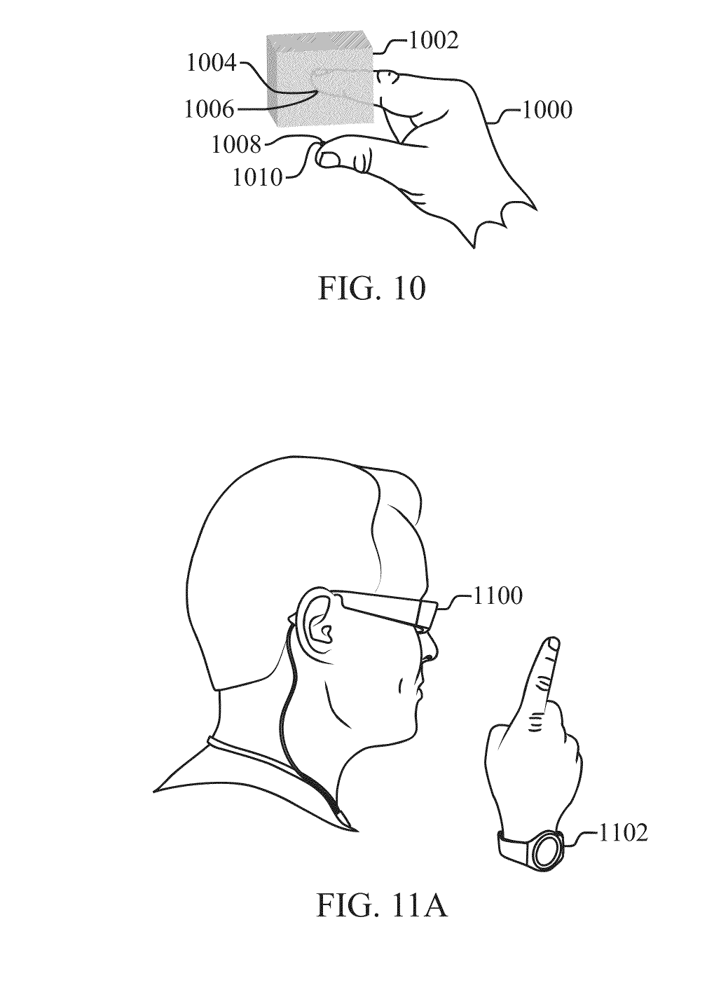

FIG. 10 illustrates the orientation of a hand 1000 and fingers relative to a virtual object 1002 at the beginning of a manipulation in a manipulative gesture in accordance with an embodiment. The embodiment relates to a manipulative operation. The user can begin manipulating the virtual object by performing a first 3D reversal fulfilling the forearm-parallel requirement. This is similar to initiating a view navigation but a different hand can be predetermined to be used for these two different tasks. The orientation of the hand 1000 and the fingers relative to the virtual object 1002 is illustrated at the time of the tip point of the first 3D reversal. The user can specify, in addition to the virtual object 1002, a fixed point 1004 within the virtual object 1002 with the fingertip 1006 of the index finger. In addition, the user can specify a reference point 1008 with the tip 1010 of the thumb. The reference point 1008 is outside of the virtual object 1002 in FIG. 10. During the manipulation of the virtual object, the virtual object 1002 is translated, rotated, and scaled in such a way that the user perceives the two points, the fixed point 1004 and the reference point 1008, to be attached to the two fingertips. This means, for example, that the user can scale or resize the virtual object 1002 by modifying the distance between the two fingertips. The user can end the virtual object manipulation by performing a second 3D reversal fulfilling the forearm-parallel requirement. With the tip point of the second 3D reversal the user can specify location to which the fixed point 1004 is moved, defining one point of the virtual object 1002 at the moved location. With the reference point 1008 the user can specify the rotation and scale of the virtual object 1002, defining the rest of the virtual object 1002 at the moved location. Rotation about the axis that passes through the fixed point 1004 and the reference point 1008 could be determined with the direction of a third point within the hand 1000 (for example).

In accordance with an embodiment, two hands could be used efficiently in 3D product, mechanical, electrical, and architectural design (for example). For example, one hand could be used for view navigation and the other for virtual object manipulation. Alternatively, both hands can be used for virtual object manipulation, which is especially powerful in assembling virtual objects together. When virtual objects are moved or copied in accordance with an embodiment, they can snap into place (possibly with probable orientation and/or size). In addition, the laws of physics can be used for snapping. For example, in architectural design, houses should not be suspended in the air.

Methods for providing selection, moving, posture, trajectorial gesture, navigational, and manipulative operations can include: registering to receive reversal events, the reversal events notifying of reversal identifications on a sampled trajectory, and receiving a reversal event, the reversal event comprising a reversal. The methods can further include steps specific to an operation, such as providing a visualization of the operation for presentation via a user interface. For example, a method for providing the selection operation can include: registering to receive reversal events, the reversal events notifying of reversal identifications on a sampled trajectory, receiving a reversal event, the reversal event comprising a reversal, in response to receiving the reversal event, determining a direction of the reversal, finding a first item towards which the reversal is based on the direction, and determining the first item as selected.

In accordance with an embodiment, a virtual environment can be attached to different frames of reference and displayed to the user on a stereoscopic display means. For example, the earth, a vehicle, a computing device, the user, and a body part of the user can be a frame of reference. Two slightly different views can be displayed for the user, one view for each eye, by the stereoscopic display means, allowing stereopsis (the user can extract depth information from the disparities between the views). Stereopsis is an important factor in perceiving depth correctly. Another important factor is motion parallax, that is, a view changes along with the motion of a head. Motion parallax can be displayed for the user on a stereoscopic display means if the orientation and the location of the stereoscopic display means is tracked when it is attached to the head of the user (as is the case with a head-mounted display, for example). Such tracking could be accomplished, for example, by using radiometric triangulation and a 3D gyroscope attached to the stereoscopic display means. Other binocular and monocular cues (such as perspective, occlusion, relative size, shading, and spatial frequency of textures) can be used to enhance visual depth perception. As an example, the earth can be used as a frame of reference when the user is not moving too much, for example when the user is in an office building. This means that when the user changes the orientation and the location of the head relative to the earth and does not navigate the view at the same time, the virtual environment is displayed to the user on the stereoscopic display means in such a way that the user perceives the virtual environment in constant location and orientation relative to the earth. In other words, if the user is not sure about the depth of a virtual object (or a virtual surface), the user can move his/her head relative to the earth for more accurate perception. Tracking data from body parts can be constructed relative to the frame of reference and visualized in the virtual environment, enabling more accurate interaction with virtual objects and virtual surfaces. If the user is moving in a vehicle, the vehicle is a good frame of reference. If the user is walking, the torso may be used as a frame of reference and parallax can be used for the motion of the head relative to the torso. The user can change the attachment within the frame of reference or to another frame of reference. In other words, the user can work with the same virtual environment whether the user is at work, at home, or commuting in between. This enables the user to continue working with the same project in the same virtual environment, having the same virtual objects and virtual surfaces (possibly with graphical elements), regardless of the physical location of the user. The stereoscopic display means may be connected to a graphics server that processes compute-intensive tasks in the user interface and the user interface can be scaled based on the capability of the graphics server.

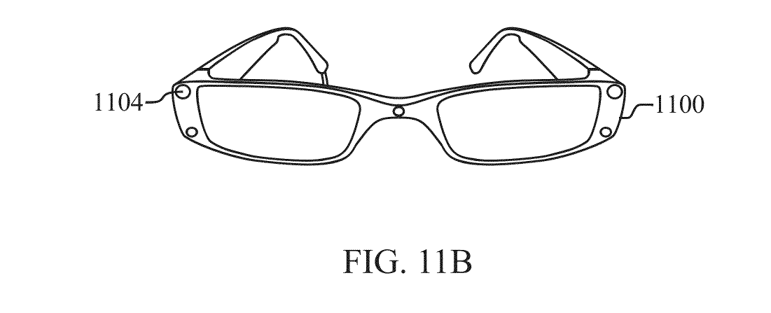

FIGS. 11A and 11B illustrate the usage of a head-mounted display 1100 and a smart watch 1102 in accordance with an embodiment. The smart is a computing device. The smart watch 1102 has a 3D accelerometer and a 3D gyroscope. A central point of the wrist joint can be estimated from the data provided by these sensors after the user has made some rotations about the forearm, that is, about the axis parallel to the forearm. More specifically, the center of rotation near the smart watch 1102 can be set as the central point of the wrist joint. As disclosed above, the central point could be used, for example, in a manipulative gesture and in a navigational gesture. The central point is a tracked point in the embodiment. The head-mounted display 1100 has a camera 1104, as illustrated in 11B. As an example, the head-mounted display 1100 and the smart watch 1102 can operate synchronously in such a way that a frame in the video (which can be 3D), recorded by the camera 1104, becomes selected at the tip point of a 3D reversal of the hand, wherein data from the sensors in the smart watch 1102 can be used to recognize the 3D reversal. Hand postures can be recognized from the frame.

In accordance with an embodiment, 3D reversals can also be utilized in a user interface even if the user sees a two-dimensional (2D) visualization. This is the case, for example, when the user is watching a visualization on a TV (without 3D viewing glasses) while the body parts are tracked in space by a game console or other entertainment appliance. For example, the user can perform hand postures and trajectorial gestures as disclosed above.

In addition, 3D reversals can also be utilized if there is more than one concurrent user in accordance with an embodiment. For example, the viewers (or listeners) can concurrently perform hand postures as disclosed above at an event (such as a sports event, a play, or a meeting). As an example, the viewers can concurrently perform thumb-up or thumb-down hand postures in order to collectively approve or disapprove of something or vote on something at the event. When the viewers' hands and fingers are tracked, sampled trajectories of tracked points can be constructed and the result can be shown in real time by recognizing hand postures at the tip points of 3D reversals. In addition, the faces of the viewers can be recognized in order to assign a hand posture to the viewer who has performed it.

In accordance with an embodiment, viewers can concurrently perform hand postures as disclosed above when watching a broadcast, wherein an entertainment appliance or a game console can be used for tracking hands and fingers as well as recognizing 3D reversals and hand postures. As an example, this would enable viewers at home to vote on something in the broadcast. Only the result need be sent back because the demanding computing is done locally by the entertainment appliance. Results from different homes can be compiled on a server and a collective result can be shown in the broadcast.

In accordance with an embodiment, a user interface may comprise a plurality of virtual objects and a plurality of virtual surfaces in a virtual environment. The user can interact with these virtual objects and virtual surfaces as disclosed above. Virtual surfaces can be context sensitive. This means, for example, that after selection of a virtual object, one or more specific virtual surfaces are displayed near, or around, the virtual object in convenient orientation for the user. A specific virtual surface comprises graphical elements for editing the virtual object.

Software, hardware, firmware, or any combination thereof may be used in a computing device for implementing the invention. Alternatively, the invention may be partly, or wholly, implemented in one or more servers which are in connection with the computing device via a communication link. The computing device may be, for example, any of the following (but not limited to): a computer (such as a tablet computer, a laptop computer and a notebook computer), a mobile phone, an entertainment appliance (such as a game console and a TV), a smart watch or a head-mounted display. The head-mounted display may be stereoscopic and it may enable virtual reality and/or augmented reality. The computing device may have access to a computer-readable medium. Instructions for implementing the invention may be included in a computer-readable medium, which may be non-transitory, or in a computer program. The instructions may be stored in one or more memory components. Examples of memory components are non-volatile memory (ROM, EPROM, EEPROM, flash memory and so on), random access memory (RAM), a disk storage device (a hard disk drive, CD, DVD, Blu-Ray Disc and so on) and a solid-state drive (SSD). The computing device may have one or more processors. The one or more processors perform processing as instructed by the instructions. The interconnection between the one or more memory components and the one or more processors, for transferring the instructions and data, typically consists of electrical conductors, known as buses (such as data bus, address bus and control bus). A system clock causes transferring to take place in an orderly manner and with specific timing.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A computer implemented method for generating reversal events in a user interface, the method comprising:
creating a sampled trajectory of an object, wherein the object is at least a portion of a body of a user of the user interface,
receiving a position event, the position event including position information of the object,
updating the sampled trajectory with the position information in response to receiving the position event,
performing reversal recognition on the updated sampled trajectory to identify a reversal, and
upon identifying the reversal, generating a reversal event in the user interface.

2. The method in accordance with claim 1, further comprising registering, to receive position events, the position events notifying of positional changes of a body part of a user.

3. A method in accordance with claim 1, wherein the reversal event comprises information on the reversal.

4. A method in accordance with claim 1, further comprising:
receiving a registration from a listener, wherein the listener declares to receive reversal events and
upon generating the reversal event, notifying registered listeners by the reversal event.

5. A method in accordance with claim 1, wherein the object is a three dimensional objection and wherein the portion of the body of the user is a portion of the user's finger.

6. A method in accordance with claim 1, wherein performing reversal recognition comprises:
calculating a rate of reversing at sampled positions in the sampled trajectory and
identifying the reversal when the rate of reversing is above a minimum rate at one or more subsequent sampled positions.

7. A method in accordance with claim 6, wherein performing reversal recognition further comprises:
determining the maximum rate of reversing among the one or more sampled positions and
determining a sampled position, of the one or more sampled positions, having the maximum rate of reversing as a tip point of the reversal.

8. A method in accordance with claim 1, wherein performing reversal recognition includes determining a correlation between two paths of the object from the updated sampled trajectory, wherein when the position of two paths of the object from the sampled trajectory meet a predetermined correlation index and the two paths have opposite trajectories, a reversal is recognized.

9. A method in accordance with claim 1, wherein the position information includes three dimensions.

10. A method in accordance with claim 1, wherein the position information is relative to a frame of reference.

11. A method in accordance with claim 10, wherein the frame of reference is one of the following: the earth, a vehicle, a computing device, the user, and another body part of the user.

12. A non-transitory computer-readable medium having stored thereon a set of instructions for causing a computer to implemented a method for generating reversal events in a user interface, the method comprising:
creating a sampled trajectory of an object, wherein the object is at least a portion of a body of a user of the user interface,
receiving a position event, the position event including position information of the object,
updating the sampled trajectory with the position information in response to receiving the position event,
performing reversal recognition on the updated sampled trajectory to identify a reversal, and
upon identifying the reversal, generating a reversal event in the user interface.

13. The method in accordance with claim 1, further comprising registering, to receive position events, the position events notifying of positional changes of a body part of a user.

14. A method in accordance with claim 1, wherein the object is a three dimensional objection and wherein the portion of the body of the user is a portion of the user's finger.

15. A method in accordance with claim 1, wherein performing reversal recognition comprises:
calculating a rate of reversing at sampled positions in the sampled trajectory and
identifying the reversal when the rate of reversing is above a minimum rate at one or more subsequent sampled positions.

16. A method in accordance with claim 1, wherein performing reversal recognition includes determining a correlation between two paths of the object from the updated sampled trajectory, wherein when the position of two paths of the object from the sampled trajectory meet a predetermined correlation index and the two paths have opposite trajectories, a reversal is recognized.

17. A system comprising;
a means for capturing position information of an object, wherein the object is at least a portion of a body of a user of a user interface,
a means for receiving position information of the object in the form of a position event, and
a means for creating a sampled trajectory of the object, updating the sampled trajectory with the position information in response to receiving the position event, performing reversal recognition on the updated sampled trajectory to identify a reversal, and upon identifying the reversal, generating a reversal event in the user interface
